(19) United States
(12) Patent Application Publication
(10) Pub. No.: US 2025/0002714 A1
(43) Pub. Date: Jan. 2, 2025

(54) FORMULA OF ANTI-CORROSION AND ANTI-ULTRAVIOLET MATERIAL

(71) Applicant: CREATIVE MOTOR TECHNOLOGY (DONGGUAN) CO., LTD., Dongguan (CN)

(72) Inventors: Yitong QI, Shenzhen (CN); Min DENG, Shenzhen (CN); Shihong XIE, Shenzhen (CN)

(73) Assignee: CREATIVE MOTOR TECHNOLOGY (DONGGUAN) CO., LTD., Dongguan (CN)

(21) Appl. No.: 18/258,791

(22) PCT Filed: Aug. 16, 2022
(86) PCT No.: PCT/CN2022/112871

§ 371 Date: Jun. 21, 2023

(30) Foreign Application Priority Data
Mar. 7, 2022 (CN) 202210221570.8

(51) Int. Cl. C08L 67/06; C03C 13/06; C08K 3/00; C08K 7/14; C08K 11/00

(52) U.S. Cl. CPC C08L 67/06; C03C 13/06; C08K 3/00; C08K 7/14; C08K 11/00; C08L 2201/08; C08L 2666/10

(57) ABSTRACT

The disclosure discloses a formula of an anti-corrosion and anti-ultraviolet material, including: 10% to 20% of unsaturated polyester resin, 5% to 10% of styrene and polystyrene, 10% to 20% of glass fiber, 35% to 45% of rock powder and 3% to 5% of other reagent. A casing of an aerator may be made of the anti-corrosion and anti-ultraviolet material of the disclosure, so as to prevent the aerator from being corroded and affecting its normal work after it works underwater for a long time.

### CROSS-REFERENCE TO RELATED APPLICATIONS

The application claims priority to Chinese patent application No. 202210221570.8, filed on Mar. 7, 2022, the entire contents of which are incorporated herein by reference.

### TECHNICAL FIELD

The disclosure particularly relates to a formula of an anti-corrosion and anti-ultraviolet material.

### BACKGROUND

An aerator is a machine that is often used in fishery and aquaculture. Its main function is to increase the oxygen content in water to prevent fish in the water from hypoxia, and it can also suppress the growth of anaerobic bacteria in the water and prevent the deterioration of pond water from threatening the living environment of fish.

The aerator is always soaked in pond water and subjected to corrosion of water and ultraviolet. The existing aerator is prone to damage if it is not maintained regularly, bringing losses to the fish pond.

### SUMMARY

The disclosure provides a technical solution to solve the above problems.

A formula of an anti-corrosion and anti-ultraviolet material includes: 10% to 20% of unsaturated polyester resin, 5% to 10% of styrene and polystyrene, 10% to 20% of glass fiber, 35% to 45% of rock powder and 3% to 5% of other reagent.

Preferably, the formula includes 10% of unsaturated polyester resin, 5% of styrene and polystyrene, 10% of glass fiber, 35% of rock powder and 3% of other reagent.

Preferably, the formula includes 15% of unsaturated polyester resin, 7% of styrene and polystyrene, 15% of glass fiber, 40% of rock powder and 4% of other reagent.

Preferably, the formula includes 20% of unsaturated polyester resin, 10% of styrene and polystyrene, 20% of glass fiber, 45% of rock powder and 5% of other reagent.

Preferably, the other reagent is a curing agent, a mold release agent, a toner or the like.

Preferably, the unsaturated polyester resin is formed by polycondensation of dibasic acid and diol or saturated dibasic acid and unsaturated diol.

Preferably, the polystyrene is a polymer synthesized from styrene monomer by free radical addition polymerization.

Preferably, the glass fiber is made from pyrophyllite, quartz sand, limestone, dolomite, calciborite and ascharite by high-temperature melting, drawing, winding and weaving.

Compared with the prior art, the disclosure has the following beneficial effects: a casing of an aerator may be made of the anti-corrosion and anti-ultraviolet material of the disclosure, so as to prevent the aerator from being corroded and affecting its normal work after it works underwater for a long time.

The additional aspects and advantages of the disclosure will be set forth in part in the description which follows, parts of which will become apparent from the description below, or will be understood by the practice of the disclosure.

### DETAILED DESCRIPTION OF THE EMBODIMENTS

The technical solutions in the embodiments of the disclosure will be clearly and completely described below. It is apparent that the described embodiments are only a part, rather than all of the embodiments of the disclosure. All other embodiments obtained by those of ordinary skill in the art based on the embodiments of the disclosure without creative work are within the protection scope of the disclosure.

In the embodiments of the disclosure, a formula of an anti-corrosion and anti-ultraviolet material includes: 10% to 20% of unsaturated polyester resin, 5% to 10% of styrene and polystyrene, 10% to 20% of glass fiber, 35% to 45% of rock powder and 3% to 5% of other reagent.

Experimental data are as follows:

| No. | Test item | | Target value | Test result | Conclusion |
|---|---|---|---|---|---|
| 1 | Drop testing | | Drop height: | No damage | Acceptable |
| | | | 3 m, no damage | | |
| 2 | Aging resistance | | After artificial | There was no | Acceptable |
| | | | weathering | obvious | |
| | | | testing under a | efflorescence or | Acceptable |
| | | | xenon lamp for | cracking on the | |
| | | | 300 h, there is | surface of the | |
| | | | no efflorescence | sample, and the | |
| | | | or cracking, and | discoloration | |
| | | | the discoloration | rating was 4-5 | |
| | | | rating is 4-5 | | |
| 3 | Flammability rating | | HB | HB | Acceptable |
| 4 | Resistance to | 30% | After soaked for | Weight change: | Acceptable |
| | chemical medium | sulfuric acid | 24 h, the weight | 1.6%; Barcol | |
| | | | change is ±5%, | hardness change: | |
| | | | and the Barcol | −1.6% | |
| | | | hardness change | | |
| | | | is ±5% | | |
| | | 5% | After soaked for | Weight change: | Acceptable |
| | | hydrochloric | 24 h, the weight | 1.4%; Barcol | |
| | | acid | change is ±5%, | hardness change: | |
| | | | and the Barcol | −3.3% | |
| | | | hardness change | | |
| | | | is ±5% | | |
| | | 5% nitric | After soaked for | Weight change: | Acceptable |
| | | acid | 24 h, the weight | 1.6%; Barcol | |
| | | | change is ±5%, | hardness change: | |
| | | | and the Barcol | 0% | |
| | | | hardness change | | |
| | | | is ±5% | | |
| | | 10% sodium | After soaked for | Weight change: | Acceptable |
| | | hydroxide | 24 h, the weight | 1.2%; Barcol | |
| | | | change is ±5%, | hardness change: | |
| | | | and the Barcol | −3.4% | |
| | | | hardness change | | |
| | | | is ±5% | | |
| | | Saturated | After soaked for | Weight change: | Acceptable |
| | | sodium | 24 h, the weight | 1.0%; Barcol | |
| | | carbonate | change is ±5%, | hardness change: | |
| | | solution | and the Barcol | 0% | |
| | | | hardness change | | |
| | | | is ±5% | | |
| | | 10% | After soaked for | Weight change: | Acceptable |
| | | ammonia | 24 h, the weight | 1.0%; Barcol | |
| | | water | change is ±5%, | hardness change: | |
| | | | and the Barcol | −1.8% | |
| | | | hardness change | | |
| | | | is ±5% | | |
| 5 | Impact testing | A 1 kg iron | After two hits, | After the testing, | Acceptable |
| | | ball falls | only cracks are | only slight cracks | |
| | | freely from | produced, and | were produced, | |
| | | a height of | no fragments | and no fragments | |
| | | 4 m and hits | larger than 4 | larger than 4 cm² | |
| | | the | cm² are | were produced | |
| | | geometric | produced | | |
| | | center of the | | | |
| | | side surface | | | |
| | | on the long | | | |
| | | side | | | |

| | | | | |
|---|---|---|---|---|
| 6 | Lead content, mg/kg | ≤1000 | N.D. (<5) | Acceptable |
| 7 | Mercury content, mg/kg | ≤1000 | N.D. (<5) | Acceptable |
| 8 | Cadmium content, mg/kg | ≤1000 | N.D. (<5) | Acceptable |
| 9 | Hexavalent chromium | ≤1000 | N.D. (<5) | Acceptable |
| | content, mg/kg | | | |
| 10 | Polybrominated diphenyl | ≤1000 | N.D. (<10) | Acceptable |
| | content, mg/kg | | | |
| 11 | Polybrominated diphenyl | ≤1000 | N.D. (<10) | Acceptable |
| | ether, mg/kg | | | |

Preferably, the formula includes 10% of unsaturated polyester resin, 5% of styrene and polystyrene, 10% of glass fiber, 35% of rock powder and 3% of other reagent.

Preferably, the formula includes 15% of unsaturated polyester resin, 7% of styrene and polystyrene, 15% of glass fiber, 40% of rock powder and 4% of other reagent.

Preferably, the formula includes 20% of unsaturated polyester resin, 10% of styrene and polystyrene, 20% of glass fiber, 45% of rock powder and 5% of other reagent.

Preferably, the other reagent is a curing agent, a mold release agent, a toner or the like.

Preferably, the unsaturated polyester resin is formed by polycondensation of dibasic acid and diol or saturated dibasic acid and unsaturated diol.

Preferably, the polystyrene is a polymer synthesized from styrene monomer by free radical addition polymerization.

Preferably, the glass fiber is made from pyrophyllite, quartz sand, limestone, dolomite, calciborite and ascharite by high-temperature melting, drawing, winding and weaving.

For those skilled in the art, it is apparent that the disclosure is not limited to the details of the above exemplary embodiments, and the disclosure can be implemented in other specific forms without departing from the spirit or basic features of the disclosure. Therefore, the embodiments should be regarded in all aspects as exemplary and non-limiting. The scope of the disclosure is defined by the appended claims rather than the description above, and therefore, it is intended that all changes falling within the meaning and scope of equivalent elements of the claims are included in the disclosure.

What is claimed is:

1. A formula of an anti-corrosion and anti-ultraviolet material, comprising: 10% to 20% of unsaturated polyester resin, 5% to 10% of styrene and polystyrene, 10% to 20% of glass fiber, 35% to 45% of rock powder and 3% to 5% of other reagent.

2. The formula of an anti-corrosion and anti-ultraviolet material according to claim 1, wherein the formula comprises 10% of unsaturated polyester resin, 5% of styrene and polystyrene, 10% of glass fiber, 35% of rock powder and 3% of other reagent.

3. The formula of an anti-corrosion and anti-ultraviolet material according to claim 1, wherein the formula comprises 15% of unsaturated polyester resin, 7% of styrene and polystyrene, 15% of glass fiber, 40% of rock powder and 4% of other reagent.

4. The formula of an anti-corrosion and anti-ultraviolet material according to claim 1, wherein the formula comprises 20% of unsaturated polyester resin, 10% of styrene and polystyrene, 20% of glass fiber, 45% of rock powder and 5% of other reagent.

5. The formula of an anti-corrosion and anti-ultraviolet material according to claim 1, wherein the other reagent is a curing agent, a mold release agent, a toner or the like.

6. The formula of an anti-corrosion and anti-ultraviolet material according to claim 1, wherein the unsaturated polyester resin is formed by polycondensation of dibasic acid and diol or saturated dibasic acid and unsaturated diol.

7. The formula of an anti-corrosion and anti-ultraviolet material according to claim 1, wherein the polystyrene is a polymer synthesized from styrene monomer by free radical addition polymerization.

8. The formula of an anti-corrosion and anti-ultraviolet material according to claim 1, wherein the glass fiber is made from pyrophyllite, quartz sand, limestone, dolomite, calciborite and ascharite by high-temperature melting, drawing, winding and weaving.
